(19) United States
(12) Patent Application Publication
(10) Pub. No.: US 2010/0113128 A1
(43) Pub. Date: May 6, 2010

(54) METHODS AND APPARATUS FOR DETERMINING A REEL STRIP POSITION

(76) Inventors: Richard N. Snow, Reno, NV (US); Richard D. Sadler, Anacortes, WA (US)

Correspondence Address: Armstrong Teasdale LLP (IGT - 26668);Robert B. Reeser, III, One Metropolitan Square, Suite 2600, St. Louis, MO, 63102, US

(21) Appl. No.: 12/265,002

(22) Filed: Nov. 5, 2008

(51) Int. Cl. G06F 17/00

(52) U.S. Cl. 463/20; 463/22

(57) ABSTRACT

A gaming device is provided, including a reel that includes a reel strip having a plurality of patterns, a sensor configured to detect a pattern of the plurality of patterns, and a controller coupled to the sensor, wherein the controller is programmed to determine an orientation of the reel strip and an identity of the reel strip based on the detected pattern.

### BACKGROUND OF THE INVENTION

The subject matter disclosed herein relates generally to gaming machines, such as slot machines, and, more specifically, to methods and apparatus for use in determining a position of a slot machine reel.

At least some known gaming machines that include reel assemblies that use indirect methods to infer that the gaming machine displays a correct set of game reel strip positions to a player. However, reel strip graphics may be improperly positioned on the reel, and/or the reel mechanism may be installed at the incorrect reel location within the gaming machine cabinet. Either of such errors may result in erroneous player displays, which may lead to disputes between the player and a casino that operates the gaming machine.

For example, at least some known reel assemblies used in gaming machines detect the rotational position of a reel by sensing rotational motion of a toothed encoder wheel that is molded into a reel cage that contains the reel. In such an assembly, a reel strip is coupled to the reel cage using an index notch that fixes the reel strip at a known orientation relative to the encoder wheel. As such, when the reel stops at a specified position, the symbol displayed to a player is inferred. If the reel strip is correctly mounted such that the notches on reel strip and the reel cage are aligned, then the inference is correct. In addition, the reel strip must be the correct one for the application for which it is used.

However, in known gaming machines and reel assemblies, there is currently no means for ensuring that the reel strip is correctly mounted and that the reel strip is appropriate for the application for which it is used. As such, a reel strip may be mounted incorrectly such that the notches are misaligned, or an incorrect reel strip may be used in the gaming machine. For example, a reel strip intended to be used on a middle reel of a gaming machine may be alternatively or unknowingly mounted on a left reel. Accordingly, it is desirable that an orientation and an identity of each reel strip used in a gaming machine be determined directly rather than inferred.

### BRIEF DESCRIPTION OF THE INVENTION

In one aspect, a gaming machine is provided. The gaming machine includes a reel strip having a plurality of patterns, a sensor configured to detect a pattern of the plurality of patterns, and a controller coupled to the sensor, wherein the controller is programmed to determine an orientation of the reel strip and an identity of the reel strip based on the detected pattern.

In another aspect, a reel assembly for use in a gaming machine is provided. The reel assembly includes a reel, which includes a reel strip having a plurality of indicia. The reel assembly also includes a sensor configured to detect a pattern of the plurality of indicia and to transmit a signal representative of the detected indicia to a gaming machine controller to facilitate determining an orientation of the reel strip and an identity of the reel strip.

In another aspect, a method for detecting a position of a reel mechanism in a gaming machine is provided. The method includes receiving a sensor signal responsive to movement of a reel strip having a plurality of reel stops, wherein the sensor signal corresponds to a particular pattern of a plurality of patterns encoded on a laminate applied to the reel strip, and determining a reel stop based on the sensor signal.

### BRIEF DESCRIPTION OF THE DRAWINGS

FIG. 1 is a perspective view of an exemplary gaming machine;

FIG. 2 is a perspective view of an exemplary slot reel assembly that may be used with the gaming machine shown in FIG. 1;

FIG. 3 is an exploded perspective view of interior parts of the slot reel assembly shown in FIG. 2;

FIG. 4 is a top view of an exemplary reel strip that may be used with the slot reel assembly shown in FIGS. 2 and 3;

FIG. 5 is a block diagram of an exemplary system used to detect a position of a slot reel in the gaming machine shown in FIG. 1; and

FIG. 6 is a flowchart showing an exemplary method for detecting a position of a slot reel in the gaming machine shown in FIG. 1.

### DETAILED DESCRIPTION OF THE INVENTION

Exemplary applications of apparatus and methods according to the present invention are described herein. These examples are provided solely to add context and to aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting. In the detailed description that follows, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

Various advantages of the present invention include the introduction of devices for use with an interactive gaming table that is more fully automated, providing added benefits to the gaming operator, and also having various automated and player-friendly items and functionalities. The devices described herein may be used to, for example, award bonus jackpots to one or more players and/or to enable one or more players to step through gaming sequences according to the actions of one or more players using such devices.

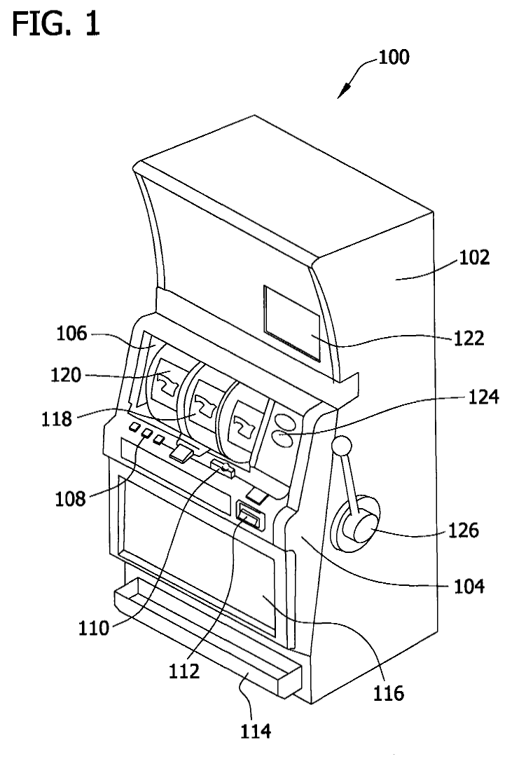

FIG. 1 is a perspective view of an exemplary gaming machine 100. In the exemplary embodiment, gaming machine 100 includes a main cabinet 102 that includes a main door 104 on a front 106 of gaming machine 100. Main door 104 is openable to provide access to the interior of gaming machine 100, and includes a locking mechanism (not shown) to limit access to the interior of gaming machine 100. A plurality of player-input buttons 108 are coupled to main door 104, along with a coin acceptor 110, a bill validator 112, a coin tray 114, and a belly glass 116. Moreover, in the exemplary embodiment, a plurality of slot reel assemblies 118 are viewable through main door 104. Each slot reel assembly 118 is covered with a reel strip (not shown in FIG. 1) that is described in more detail below. Slot reel assemblies 118 are positioned behind a display panel 120. A video display monitor 122 is located above main door 104. In one embodiment, video display monitor 122 is a cathode ray tube (CRT) monitor. In another embodiment, video display monitor 122 is a liquid crystal display (LCD) monitor. Various embodiments of gaming machine 100 may utilize video display monitor 122 to provide additional features, such as bonus games and/or attract sequences, to a base game being played on gaming machine 100.

Moreover, in the exemplary embodiment, gaming machine 100 also includes an information panel 124 positioned adjacent slot reel assemblies 118. In the exemplary embodiment, information panel 124 is a back-lit, silk-screened glass panel, and includes lettering or other indicia that indicate general game information such as a number of coins played. Gaming machine 100 also includes a slot reel handle 126 coupled to main cabinet 102. Slot reel handle 126 may be used by a player to activate slot reel assemblies 118 during game play. In addition, the player may interact with bill validator 112, player-input buttons 108, video display monitor 122, and information panel 124 during game play. Each of these devices is controlled by circuitry (not shown in FIG. 1) housed within main cabinet 102.

During play of gaming machine 100, a player inserts cash using bill validator 112 and/or coin acceptor 110. Alternatively, the player may insert a ticket into bill validator 112, wherein the ticket is worth a predefined amount of money or credits. At the start of the game, the player initiates game play by pulling on slot reel handle 126 or by pressing one of the plurality of player-input buttons 108. During the game, the player may view additional game information and/or be presented with additional game options using video display monitor 122 and/or information panel 124. Moreover, during the game, the player may be prompted to make a number of decisions that may affect the outcome of the game. The player may input such decisions using player-input buttons 108. Further, during certain game events, gaming machine 100 may display visual effects and/or emit audible effects that are perceived by the player in order to add excitement to the game. Visual effects may include, but are not limited to only including, flashing lights, strobing lights, and/or other patterns displayed by lights (not shown) on gaming machine 100 and/or positioned behind belly glass 116. Moreover, visual effects may be displayed via patterns on video display monitor 122 and/or from lights (not shown) positioned on slot reel assemblies 118. Auditory effects may include, but are not limited to only including, various sounds that are projected by speakers (not shown). After a game is completed, the player may receive game tokens or coins from coin tray 114.

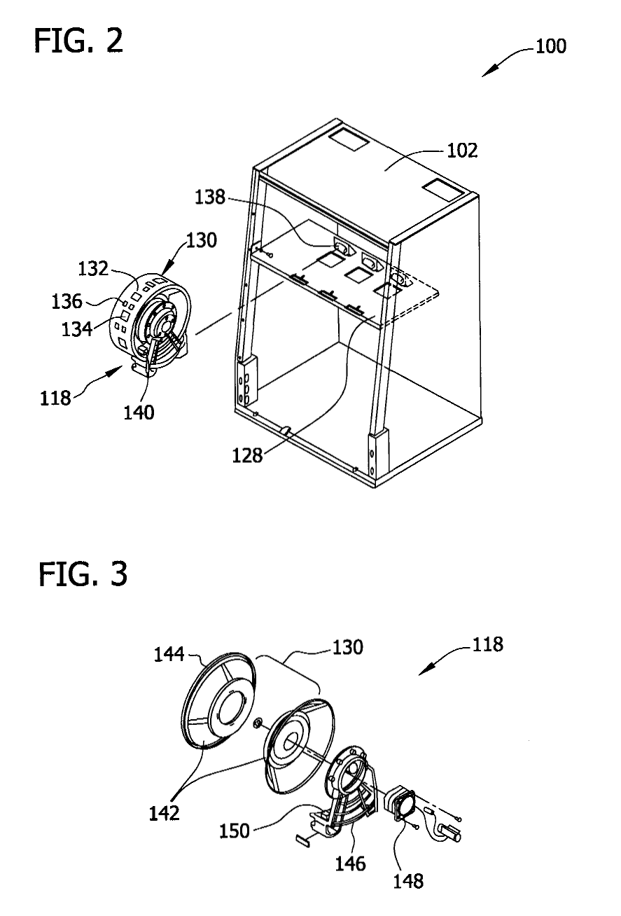

FIG. 2 is a perspective view of an exemplary slot reel assembly 118 that may be used with gaming machine 100 (shown in FIG. 1). In the exemplary embodiment, a reel shelf 128 within main cabinet 102 supports multiple slot reel assemblies 118. Each slot reel assembly 118 includes a slot reel 130 that includes a reel strip 132 applied thereto. Each reel strip 132 is covered with a plurality of symbols 134 that are utilized during game play. Additionally, in the exemplary embodiment, reel strip 132 also includes a plurality of identification patterns 136 and/or marks that each correspond to a particular reel stop. Moreover, in the exemplary embodiment, each slot reel assembly 118 is coupled to a mating connector 138. Mating connector 138 provides connections to a power supply (not shown) and to control circuitry (not shown) housed within main cabinet 102. Further, slot reel assembly 118 includes an infrared (IR) light emitter 140 that emits IR light through reel strip 132. In the exemplary embodiment, IR emitter 140 is positioned in an interior space of reel strip 132 and is oriented to direct IR light through reel strip 132 into the exterior of reel strip 132. In an alternative embodiment, IR emitter 140 is coupled to reel chassis 146 and is oriented to direct IR light through reel strip 132 into an interior space of reel strip 132.

FIG. 3 is an exploded perspective view of interior parts of slot reel assembly 118. In the exemplary embodiment, slot reel 130 includes two reel halves 142. In the exemplary embodiment, reel strip 132 (shown in FIG. 2) is positioned over an edge 144 of each reel half 142. Reel halves 142 are supported by a reel chassis 146 mounted to reel shelf 128 (shown in FIG. 2), as described above. Prior to game play, each slot reel 130 is typically motionless. Upon game initiation, each slot reel 130 is set in a rotating motion by a stepper motor 148 mounted to reel chassis 146 and coupled to each reel half 142 to facilitate rotation of each slot reel 130. Stepper motor 148 accelerates each reel half 142 to a desired rotational velocity and stops each reel half 142 at a predetermined position. Moreover, in the exemplary embodiment, slot reel assembly 118 includes an infrared (IR) light sensor 150 that detects IR light emitted through reel strip 132 by IR emitter 140. In the exemplary embodiment, IR sensor 150 is positioned exterior to reel strip 132 in order to detect IR light emitted from IR emitter 140, which is positioned within the interior space of reel strip 132 such that the IR light emitted by IR emitter 140 passes through reel strip 132 into the exterior of reel strip 132. In an alternative embodiment, IR sensor 150 is positioned in an interior space of reel strip 132 and is oriented to detect IR light emitted exterior to reel strip 132 such that the IR light passes through reel strip 132 into the interior space.

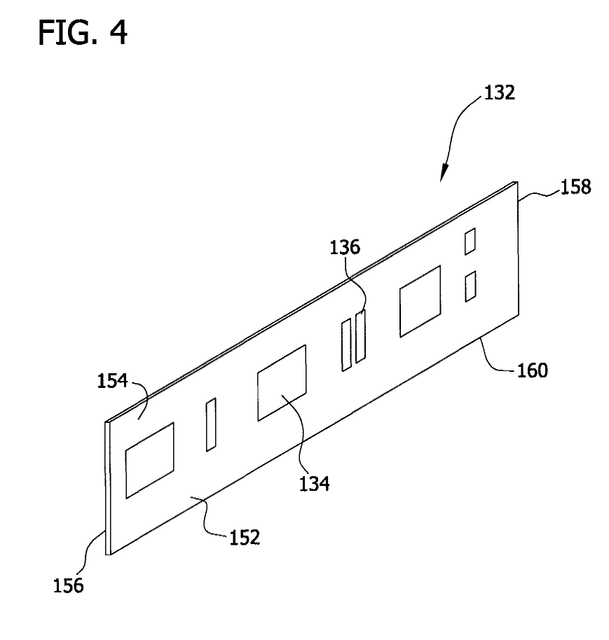

FIG. 4 is a top view of an exemplary reel strip, such as reel strip 132 (shown in FIG. 2). As described above, reel strip 132 includes a plurality of symbols 134 that may be displayed to a player of gaming machine 100 (shown in FIGS. 1 and 2). In the exemplary embodiment, reel strip 132 includes a laminate 152 that is transparent to visible light and opaque to infrared (IR) light. Laminate 152 includes a plurality of patterns 136 or markings that each identify a particular reel stop along reel strip 132. More specifically, each pattern 136 enables IR light to pass through laminate 152. In one embodiment, laminate 152 is applied to a top surface 154 of reel strip 132 between a first end 156 and an opposite second end 158. In an alternative embodiment, laminate 152 is embedded within reel strip 132. In another alternative embodiment, laminate 152 is applied to a bottom surface 160 of reel strip 132.

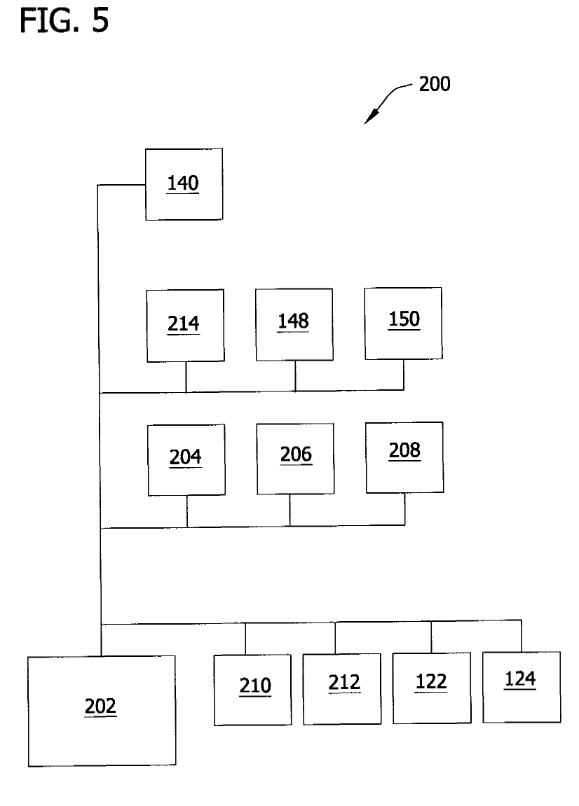

FIG. 5 is a block diagram of an exemplary system 200 that may be used to detect a position of a slot reel, such as slot reel 130 (shown in FIG. 2), using infrared (IR) light. In the exemplary embodiment, system 200 includes a master gaming controller 202 that controls a plurality of devices including, but not limited to only including, an effects light 204, a back light 206, a sound device 208, a printer 210, a touch screen 212, information panel 124, and/or video display monitor 122. Moreover, master gaming controller 202 is communicatively coupled to a gaming network controller (not shown) to facilitate communicating information to the gaming network controller including, but not limited to only including, status information of gaming machine 100 (shown in FIG. 1) and/or alarm information relating to gaming machine 100, slot reel 130, and/or reel strip 132. Further, master gaming controller 202 also controls a slot reel controller 214, stepper motor 148, IR emitter 140, and IR sensor 150. Using standard communication connections, master gaming controller 202 transmits instructions to a device to perform a specific function. In the exemplary embodiment, master gaming controller 202 transmits low-level instructions to devices that are directly controlled by master gaming controller 202, such as turning on a particular light, turning off a particular light, starting a motor, and/or stopping a motor. In addition, master gaming controller 202 transmits high-level instructions to slot reel controller 214 to, for example, stop each slot reel 130 at a particular reel stop. Further, master gaming controller 202 stores an identifier associated with each reel strip 132 to facilitate ensuring that each reel strip 132 is coupled to an expected slot reel assembly 118. Moreover, in the exemplary embodiment, master gaming controller 202 stores a listing of each pattern 136 encoded within laminate 152 and a reel stop associated with each pattern 136 to facilitate ensuring that slot reel 130 stops at a desired reel stop.

In the exemplary embodiment, effects light 204 includes at least one light that may be activated during the course of game play to add excitement for a player. The light may be activated in one or more patterns such as, but not limited to, a strobing pattern and/or a flashing pattern. Back light 206 provides visible light that illuminates each symbol 134 on reel strip 132 (both shown in FIGS. 2 and 4). Moreover, sound device 208 provides various sound effects during the course of game play. Such sound effects may include the sound of a slot reel making a clicking noise and/or any other sound pattern used to add excitement and interest during game play. Sound device 208 may include one or more speakers (not shown) and an amplifier (not shown) that provides power to the speakers. Further, in the exemplary embodiment, master gaming controller 202 is operatively coupled to IR emitter 140 and IR sensor 150.

During operation, an outcome of a game is typically determined by the symbols 134 displayed to the player on each slot reel 130. Different combinations of symbols 134 may result in different game outcomes. The probability of a particular symbol 134 appearing on a slot reel 130 may be determined by software residing on master gaming controller 202. When a game is initiated by a player, master gaming controller 202 randomly selects a particular symbol 134 that should appear on each slot reel 130. Master gaming controller 202 transmits instructions to slot reel controller 214 to initiate a sequence wherein slot reel 130 is initially spun and then stopped at a position, or reel stop, that corresponds to the selected symbol 134.

In the exemplary embodiment, motion of slot reel 130 is controlled by stepper motor 148 (shown in FIG. 3) based on, for example, motor parameters such as, but not limited to, acceleration constants and/or a desired step rate, and/or on slot reel assembly parameters such as a moment of inertia. For example, stepper motor 148 starts rotation of slot reel 130 from an initial stationary position, accelerates slot reel 130 to a desired rotational velocity, and then decelerates slot reel 130 in discrete steps. Finally, stepper motor 148 stops slot reel 130 at a desired reel stop that is transmitted by master gaming controller 202 to slot reel controller 214.

To verify that the symbol displayed by each slot reel 130 and/or to verify that a correct reel strip 132 has been included in each slot reel assembly 118, IR emitter 140 emits IR light through reel strip 132 towards IR sensor 150. More specifically, IR emitter 140 emits IR light through patterns 136 encoded in laminate 152, and the patterned IR light is detected by IR sensor 150. IR sensor 150 then generates a signal representative of the detected pattern 136 and transmits that signal to master gaming controller 202, wherein the signal is processed. Master gaming controller 202 determines the sensed pattern 136 and compares the sensed pattern 136 to the stored listing of patterns 136 and associated reel stops to determine whether the desired reel stop has been used for slot reel 130. As such, master gaming controller 202, IR emitter 140, IR sensor 150, and laminate 152 including patterns 136 facilitate ensuring a correct alignment of each reel strip 132.

Moreover, in the exemplary embodiment, master gaming controller 202 periodically determines that each slot reel assembly 118 includes a desired reel strip 132. A particular pattern 136 encoded in laminate 152 is detected by IR sensor 150 as described above. IR sensor 150 generates a signal representative of the sensed pattern 136 and transmits the signal to master gaming controller 202. In the exemplary embodiment, master gaming controller 202 determines a reel strip identity based on the sensed pattern 136 and compares the determined reel strip identity to the stored listing of patterns 136 and associated reel strip identities to determine whether the desired reel strip 132 has been used for each slot reel assembly 118. As such, master gaming controller 202, IR emitter, IR sensor 150, and laminate 152 including patterns 136 facilitate ensuring a correct application of a desired reel strip 132 to each slot reel assembly 118.

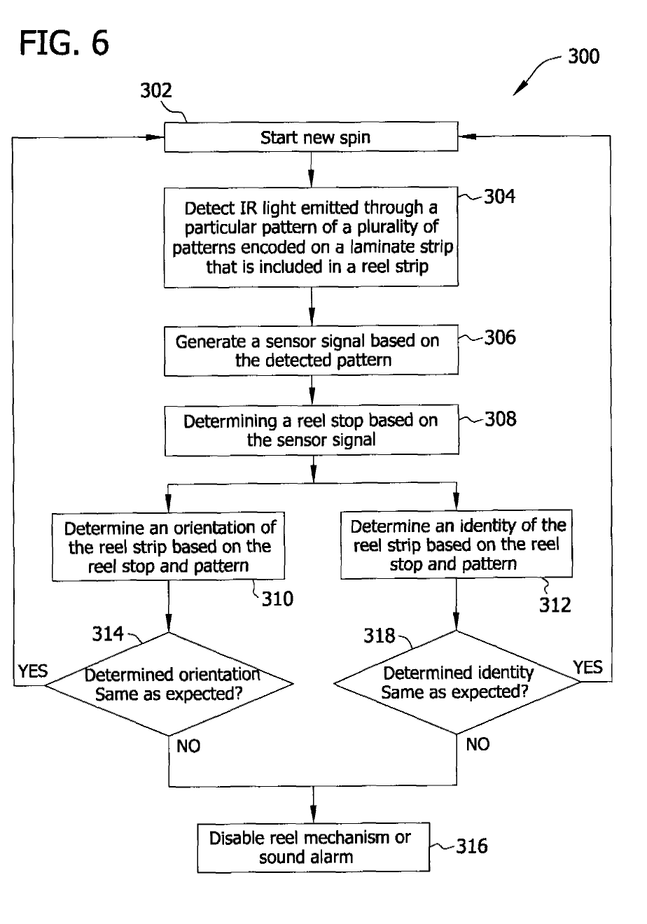

FIG. 6 is a flowchart illustrating an exemplary method 300 for detecting a position of a slot reel, such as slot reel 130 (shown in FIG. 2), in a gaming machine, such as gaming machine 100 (shown in FIGS. 1 and 2). In the exemplary embodiment, master gaming controller 202 (shown in FIG. 5) instructs stepper motor 148 (shown in FIG. 3) to rotate slot reel 130 in response to a player command to initiate a new spin 302. Stepper motor 148 rotates slot reel 130 from an initial stationary position, accelerates slot reel 130 to a desired rotational velocity, and then decelerates slot reel 130 in discrete steps. Finally, stepper motor 148 stops slot reel 130 at a desired reel stop that is transmitted by master gaming controller 202 to slot reel controller 214 (shown in FIG. 5).

Prior to the spin, and during the spin, master gaming controller 202 also instructs an IR emitter 140 (shown in FIG. 2) to emit IR light through a reel strip 132 (shown in FIG. 2) that includes a laminate 152 (shown in FIG. 4) having a plurality of patterns 136 (shown in FIG. 4) encoded thereon. An IR sensor 150 (shown in FIGS. 3 and 5) detects 304 a particular pattern 136, upon stoppage of slot reel 130, and generates 306 a signal representative of the detected pattern 136. IR sensor 150 transmits the signal to master gaming controller 202, and master gaming controller 202 determines 308 a reel stop based on the detected pattern 136. In the exemplary embodiment, master gaming controller 202 then determines 310 an orientation of reel strip 132 based on the determined reel stop. Moreover, master gaming controller 202 determines 312 an identity of reel strip 132 based on the determined reel stop. In an alternative embodiment, IR sensor 150 may detect a particular pattern 136 prior to rotation of slot reel 130 to facilitate determining an identity of reel strip 132.

In the exemplary embodiment, master gaming controller 202 compares 314 the determined orientation of reel strip 132 to a desired orientation of reel strip 132. If the determined orientation of reel strip 132 does not match the desired orientation, master gaming controller 202 disables 316 slot reel assembly 118. Alternatively, master gaming controller 202 may generate an alarm through sound device 208 (shown in FIG. 5) to reflect an incorrect orientation of reel strip 132 and to enable gaming machine 100 to be repaired and/or removed from play. Moreover, in the exemplary embodiment, master gaming controller 202 compares 318 the determined identity of reel strip 132 to a desired identity of reel strip 132. If the determined identity of reel strip 132 does not match the desired identity, master gaming controller 202 disables 316 slot reel assembly 118. Alternatively, master gaming controller 202 may generate an alarm through sound device 208 (shown in FIG. 5) to reflect an incorrect identity of reel strip 132.

In addition to generating an alarm through sound device 208, master gaming controller 202 may communicate a status of gaming machine 100 (shown in FIG. 1) to a gaming network controller (not shown). Alternatively, master gaming controller 202 may communicate the reel strip identity and/or orientation to the gaming network controller to match against a desired reel strip identity and/or orientation. For example, master gaming controller 202 may send a message or signal to the gaming network controller that includes the determined reel strip identity and/or reel strip orientation. The gaming network controller may then compare the determined reel strip identity and/or reel strip orientation to a stored, or desired, reel strip identity and/or reel strip orientation. If a match occurs, the gaming network controller may then send a message or signal to master gaming controller 202 that instructs master gaming controller 202 to enable further play at gaming machine 100. If a mismatch occurs, the gaming network controller may send a message or signal to master gaming controller 202 that instructs master gaming controller to disable gaming machine 100. Moreover, the gaming network controller may send notification to service and/or casino personnel. Similarly, master gaming controller 202 may send a message or signal to the gaming network controller that includes a notification of a reel strip identity mismatch from an expected identity and/or a reel strip orientation mismatch from an expected orientation. Further, master gaming controller 202 may send a message or signal to the gaming network controller that includes a notification of when a reel strip identity and/or a reel strip orientation is changed. Such messages and/or signals enable the gaming network controller to confirm whether the proper reel strip symbols are being displayed to the player. Moreover, such messages and/or signals enable the gaming network controller to confirm that a game downloaded to gaming machine 100 has a corresponding set of reel strips being displayed to the player.

In addition, when a reel strip identity mismatch occurs, the gaming network controller may determine if an alternate game exists that corresponds to the actual reel strip identity received by the gaming network controller from master gaming controller 202. More specifically, the gaming network controller may determine whether a game exists that corresponds to the actual reel strip identity. The gaming network controller may then originate a game program download to gaming machine 100. In some embodiments, the master gaming controller 202 may direct gaming machine 100 to display a message to a current player and/or potential players that gaming machine 100 is currently being serviced, or is currently downloading a new game. Alternatively, the gaming network controller may offer a current player an opportunity to originate a game program download to gaming machine 100, such that the player may then correctly continue play at gaming machine 100 with a game that corresponds to the actual reel strip identity.

The above-described methods and apparatus enable a gaming machine to automatically determine whether a desired reel strip has been correctly installed based on a reel stop determined by emitting IR light through a series of patterned marks encoded in a laminate applied to, or embedded within, the reel strip. Ensuring that a desired reel strip has been installed in a gaming machine and/or ensuring that the reel strip has been installed with a desired orientation facilitates preventing disputes resulting from incorrect payouts of gaming machines and enhances playing experience to the player. Moreover, ensuring the correct identity and/or orientation of the reel strip facilitates preventing installation of counterfeit reel strips. Further, games having such measures may be advertised to distinguish such games from competitors as being more likely to accurately reflect wins and/or winnings.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gaming machine comprising:
a reel comprising a reel strip, said reel strip comprising a plurality of patterns;
a sensor configured to detect a pattern of the plurality of patterns; and
a controller coupled to said sensor, said controller programmed to determine an orientation of said reel strip and an identity of said reel strip based on the detected pattern.

2. A gaming machine in accordance with claim 1, wherein said reel strip further comprises a laminate layer, the plurality of patterns are encoded on said laminate layer.

3. A gaming machine in accordance with claim 2, wherein said laminate layer comprises a filter layer configured to block infrared (IR) light from traveling through said laminate layer.

4. A gaming machine in accordance with claim 3, further comprising a light emitter coupled to said controller, said light emitter configured to emit IR light towards said sensor.

5. A gaming machine in accordance with claim 4, wherein said reel strip is positioned between said light emitter and said sensor such that IR light emitted by said light emitter travels through the detected pattern of the plurality of patterns of said laminate layer and is sensed by said sensor.

6. A gaming machine in accordance with claim 3, wherein an identifier is encoded in each pattern of the plurality of patterns such that emitted IR light traveling through the identifier of each pattern is sensed by said detector.

7. A gaming machine in accordance with claim 1, wherein said controller is programmed to:
determine a reel stop based on the pattern detected by said sensor;
determine the orientation of said reel strip and an identity of said reel strip based on the determined reel stop; and
compare the orientation of said reel strip to a predetermined orientation of said reel strip; and
compare the identity of said reel strip to a predetermined identity of said reel strip.

8. A gaming machine in accordance with claim 7, wherein said controller is further programmed to generate an alarm signal when the orientation of said reel strip does not match the predetermined orientation of said reel strip.

9. A gaming machine in accordance with claim 7, wherein said controller is further programmed to generate an alarm signal when the identity of said reel strip does not match the predetermined identity of said reel strip.

10. A gaming machine in accordance with claim 7, wherein said controller is further programmed to disable said gaming machine when the orientation of said reel strip does not match the predetermined orientation of said reel strip.

11. A gaming machine in accordance with claim 7, wherein said controller is further programmed to disable said gaming machine when the identity of said reel strip does not match the predetermined identity of said reel strip.

12. A gaming machine in accordance with claim 7, wherein said controller is further programmed to transmit a message to a gaming network controller in order to report a mismatch of at least one of the determined orientation of said reel strip and the determined identity of said reel strip.

13. A gaming machine in accordance with claim 12, wherein said controller is further programmed to disable said gaming machine responsive to a message received from the gaming network controller when the mismatch of at least one of the determined orientation of said reel strip and the determined identity of said reel strip is determined.

14. A gaming machine in accordance with claim 12, wherein said gaming controller is further programmed to download a new game for play at said gaming machine responsive to a prompt by a gaming network controller that the new game is available for download and matches the determined identity of said reel strip.

15. A reel assembly for use in a gaming machine, said reel assembly comprising:
a reel comprising a reel strip, said reel strip comprising a plurality of indicia; and
a sensor configured to detect a pattern of the plurality of indicia and to transmit a signal representative of the detected pattern to a gaming machine controller to facilitate determining an orientation of said reel strip and an identity of said reel strip.

16. A reel assembly in accordance with claim 15, wherein said reel strip further comprises a laminate layer, the plurality of indicia encoded on said laminate layer.

17. A reel assembly in accordance with claim 16, wherein said laminate layer comprises a filter layer configured to block infrared (IR) light from traveling through said laminate layer.

18. A reel assembly in accordance with claim 17, further comprising a light emitter coupled to said controller, said light emitter configured to emit IR light towards said sensor.

19. A reel assembly in accordance with claim 18, wherein said reel strip is positioned between said light emitter and said sensor such that IR light emitted by said light emitter travels through said laminate layer and is sensed by said sensor.

20. A reel assembly in accordance with claim 17, wherein an identifier is encoded in each indicia of the plurality of indicia such that emitted IR light traveling through the identifier of each indicia is sensed by said detector.

21. A reel assembly in accordance with claim 15, wherein said reel assembly is configured to be disabled by the gaming machine controller when the orientation of said reel strip does not match a predetermined orientation of said reel strip.

22. A gaming device in accordance with claim 15, wherein said reel assembly is configured to be disabled by the gaming machine controller when the identity of said reel strip does not match a predetermined identity of said reel strip.

23. A method for detecting a position of a reel mechanism in a gaming machine, said method comprising:
receiving a sensor signal responsive to movement of a reel strip having a plurality of reel stops, wherein the sensor signal corresponds to a particular pattern of a plurality of patterns encoded on a laminate applied to the reel strip; and
determining a reel stop based on the sensor signal.

24. A method in accordance with claim 23, wherein the laminate is positioned between an IR light emitter and the sensor, said method further comprising emitting infrared (IR) light towards a sensor configured to detect the particular pattern and generate the sensor signal.

25. A method in accordance with claim 24, wherein receiving a sensor signal comprises generating the sensor value based on IR light that travels through the particular pattern encoded on the laminate.

26. A method in accordance with claim 23, further comprising:
determining an orientation of the reel strip based on the determined reel stop; and
comparing the orientation of the reel strip to a predetermined orientation of the reel strip.

27. A method in accordance with claim 26, further comprising disabling the reel mechanism when the orientation of the reel strip does not match the predetermined orientation of the reel strip.

28. A method in accordance with claim 23, further comprising:
determining an identity of the reel strip based on the determined reel stop; and
comparing the identity of the reel strip to a predetermined identity of the reel strip.

29. A method in accordance with claim 28, further comprising disabling the reel mechanism when the identity of the reel strip does not match the predetermined identity of the reel strip.
